(19) United States
(12) Patent Application Publication
(10) Pub. No.: US 2015/0356579 A1
(43) Pub. Date: Dec. 10, 2015

(54) INTELLIGENT CUSTOMER-CENTRIC FEEDBACK MANAGEMENT

(71) Applicant: SureCritic, Inc., Seattle, WA (US)

(72) Inventors: David Anthony Brondstetter, Seattle, WA (US); Timothy Tew Fiorito, Seattle, WA (US); Matthew Royce Ullman, Seattle, WA (US); Cory Nicholas Osborn, Seattle, WA (US)

(21) Appl. No.: 14/727,606

(22) Filed: Jun. 1, 2015

Related U.S. Application Data
(60) Provisional application No. 62/007,596, filed on Jun. 4, 2014.

(51) Int. Cl. G06Q 30/02; G06N 5/04

(52) U.S. Cl. CPC G06Q 30/0203; G06N 5/046; G06Q 30/0282

(57) ABSTRACT

A customer-centric feedback system is described herein that focuses attempts to gather customer feedback around the customer so that business rules can be applied to more effectively manage all of the feedback events associated with the customer in a unified and logical way. If the customer just had a bad experience with the merchant's service department, it may not be a good time to ask the customer about a purchase from the merchant's sales department. By being aware of both feedback events, and the outcome of the first event, the system could delay a second survey related to the second event until it is known that the customer's problem with the first event has been satisfactorily resolved. Knowledge of both events allows the system to increase accuracy of feedback gathered for the second event by preventing dissatisfaction from the first event from bleeding over to feedback for the second event.

### CROSS-REFERENCE TO RELATED APPLICATIONS

The present application claims the benefit of U.S. Provisional Patent Application No. 62/007,596 (Attorney Docket No. SURECRITIC01) entitled “SYSTEM FOR CUSTOMER FEEDBACK PROCESS MANAGEMENT,” and filed on 2014 Jun. 4, which is hereby incorporated by reference.

### BACKGROUND

Almost any type of organization today that provides a product or service is interested in customer feedback. Merchants that sell goods want to know how satisfied customers are with the goods, how well the process of shipping the goods to the customer went, whether the customer would recommend the merchant to other potential customers, and so forth. Organizations that provide services may want to know whether customers are satisfied with the services they receive, whether there are other services they might like to receive, and so on. When disputes or dissatisfaction occurs, these organizations may want to determine how the dispute may be resolved and whether the dispute was resolved to the customer's satisfaction. Even non-profit organizations like charities, government entities, and others may look to customer feedback to determine how well they are meeting their goals. In some cases, the degree of meeting these goals may be tied to how much funding they receive. In the case of for-profit entities, the degree of satisfying customers directly affects their reputations, future customer transactions, and thus future profit. Customer feedback is an important metric for organizations of all types.

Customer feedback is often sampled by sending customers a survey or providing one in person. An event that leads to a desire within an organization to obtain customer feedback is called a feedback event herein. Any contact between the organization and customer to provide a good, service, or other interaction is a contact event. Not all contact events may be selected as opportunities to gather feedback, so a feedback event refers to those specific contact events for which the organization desires to gather feedback. Contact/feedback events may include a customer buying a product/good, such as a vehicle, obtaining a service, such as an oil change or other repair, interacting with a particular entity, such as a government office, and so forth.

A communication related to gathering that feedback is called feedback request-related messaging or a “feedback request” herein. Feedback requests may include in-person attempts to collect feedback at the time of a purchase or service, emails to the customer after the purchase/service is complete, calls to the customers, a web page soliciting feedback, and any other form of contact with the customer. There may be multiple feedback requests with a customer all related to a particular feedback event, and they may involve such elements as alerting the customer to an upcoming feedback request such as a survey, providing access to the feedback instrument along with associated instructions, reminding the customer to provide the requested feedback, incentivizing the customer, thanking the customer, providing a response to the customer's feedback, and rewarding the customer for complying with the feedback request. For example, an initial survey request by email may be followed up by a reminder if the customer does not provide any feedback after a certain time.

Although substantial work has been put into how to increase customer participation in gathering customer feedback, feedback events are still largely silos that occur and are handled individually. For example, many organizations hire different third parties to gather feedback for the different ways the organizations interact with customers. A car manufacturer may have one process for gathering feedback about new vehicle purchases and another process for gathering feedback about customers' service experiences at car dealerships. Many techniques have been applied in isolation to increase compliance with feedback requests, but little has been done to recognize how the relatedness of various feedback events impacts customer compliance in responding to the feedback request, customer provision of valid (non-skewed) responses, and customer perception of the organization and its products and services stemming from the consideration of customer sensibilities in the various feedback requests and the incentives and rewards provided by the organization. For example, all of a particular organization's feedback events to a particular customer may be experienced as related, at least in that customer's mind. A customer's dissatisfaction with one of an organization's feedback events can bleed over into a customer's impression of another of the organization's feedback events, and perhaps even of the feedback events of other organizations. For example, if a customer has just had a terrible experience with a car dealership's service department, it may affect the same customer's feedback when asked about a new car purchased at the dealership around the same time, and the customer's feedback on a different dealer's service soon after.

By not recognizing correlations between feedback events, current systems may gather inaccurate results. In addition, by being unaware of other feedback events, current systems often annoy the customer by inundating the customer with contemporaneous requests for feedback on multiple feedback events, often communicated by different divisions of the organization or different agents or vendors working on behalf of the organization. The customer's annoyance may then result in reduced compliance in responding to feedback requests, and negatively color feedback that they do provide. Further, even if the customer is compliant with the request and provides valid feedback that is not skewed by their annoyance, the customer's receipt of multiple overlapping messages related to multiple feedback events with no organizational recognition of the customer's attitudes about the different feedback events may leave the customer feeling hounded, inconvenienced, ignored, and unappreciated by the organization. This may then further damage the customer's overall level of satisfaction with the organization and perception of its related brands, while at the same time incurring additional costs to the organization as it engages in additional concern resolution steps, compensatory efforts, and so forth to unravel the various causes of dissatisfaction and repair the relationship with the customer.

### BRIEF DESCRIPTION OF THE DRAWINGS

FIG. 1 is a block diagram that illustrates components of the customer-centric feedback system, in one embodiment.

FIG. 2 is a flow diagram that illustrates processing of the customer-centric feedback system to set up the system to handle feedback for a particular organization, in one embodiment.

FIG. 3 is a flow diagram that illustrates processing of the customer-centric feedback system to publish a feedback request, in one embodiment.

FIG. 4 is a flow diagram that illustrates processing of the customer-centric feedback system to manage feedback state associated with a customer, in one embodiment.

FIG. 5 is a flow diagram that illustrates processing of the customer-centric feedback system at the time a customer accesses a previously published feedback request, in one embodiment.

### DETAILED DESCRIPTION

A customer-centric feedback system is described herein that focuses customer feedback attempts around the customer so that business rules can be applied to more effectively manage all of the feedback events associated with the customer in a unified and logical way. Existing systems are focused on individually handling feedback events. If a merchant that sells goods is conducting a customer survey to determine satisfaction with a particular product, that survey is organized around gathering feedback for that particular product. If the merchant is also conducting a customer survey related to post-purchase service of the product, that survey is generally handled separately, and may even be handled by different teams within the merchant organization or even by different third party feedback gathering companies. The customer-centric feedback system changes this model by recognizing that from the customer's perspective, all of the feedback events for which that customer is contacted for feedback, as well as the volume, nature, timing, and so on of the feedback requests, are somewhat related, and impact the customer's willingness to comply with the feedback requests, ability to provide valid, non-skewed feedback about the distinct feedback events being surveyed, experience of the convenience, efficiency, and ease of interaction with the merchant, and overall perception of and level of satisfaction with the organization and its brands.

If the customer just had a bad experience with the merchant's service department, it may not be a good time to ask the customer about a purchase from the merchant's sales department. By being aware of both feedback events, and the outcome of the first event, the system could delay a second survey related to the second event until it is known that the customer's problem with the first event has been satisfactorily resolved. Knowledge of both events allows the system to increase accuracy of feedback gathered for the second event by preventing dissatisfaction from the first event from bleeding over to feedback for the second event. In addition, by knowing about various feedback events the system can decide how to order and send feedback requests related to the feedback events. For example, a particular user of the system might create business rules indicating that a customer should only be asked to complete one survey at a time. The system can then send out a survey for a first feedback event, along with any reminders at particular intervals, and delay sending out a survey for a second feedback event until the first one is complete. As noted above, the outcome of the first feedback event may also be part of business rules that determine when the second feedback event leads to contact with the customer, or whether the system will even proceed with any feedback requests related to that second feedback event (e.g., there may also be business rules that eliminate the decision to proceed with feedback requests for the previously identified second feedback event). In another example, business rules and system logic might replace an initially slated message to the customer requesting completion of a satisfaction survey for a latter feedback event with a “we're sorry” message and compensatory “free oil change” coupon after ascertaining from a survey response about a prior feedback event such as a routine oil change that the customer's dissatisfaction with the oil change service has not yet been addressed or remains unresolved. Thus, the customer-centric feedback system increases accuracy of feedback gathered and more effectively manages the relationship with the customer by having a high-level awareness of multiple feedback events related to the same customer.

When operated by a third party to the organization/merchant, the customer-centric feedback system may also manage feedback events across multiple organizations. For example, if a customer can be identified by some unique identifier (e.g., name, email address, social security number, or any other identifier that is normally aligned with a particular individual), then whether the customer is buying a car, shopping at a retail store, seeing a movie, or any other experience that leads to a request for feedback, the system can apply business rules to intelligently gather feedback for all of the feedback events.

As discussed above, whether operating for a single organization or multiple organizations, the customer-centric feedback system has an inherent notion of identifying each customer. This can include any well-known identifier like those mentioned above as well as by proprietary or organization-specific identifiers. For example, for car related feedback events, the vehicle identification number (VIN) might be one way that an organization chooses to identify the customer. The system also manages a notion of feedback events. Organizations that use the system can model feedback events within the system that align with the organization's interactions with the customer. For example, a particular organization that sells goods might consider each purchase or visit by a customer to be a feedback event that can be modeled in the system. For an organization that offers services, each service rendered could be modeled as a feedback event by the system. This may include services for which there are no charges, such as information provided on an organization's website describing its goods and services or instructing customers on how they may interact with or contact the organization.

The system also has a notion of ways of gathering feedback, such as particular survey forms. An organization may create survey forms using tools provided by the system, and/or the system may offer a set of default forms, question types, or other tools for gathering feedback. An organization can associate a particular form with a particular feedback event, and the system can then manage the process of getting that survey completed by customers, as well as understanding the customers' survey responses to drive other behavior within the system, including dynamically modifying following questions and elements on the same or follow-up forms. Finally, the system also has a notion of business rules that define behavior that each organization (and potentially the system itself) wants to get out of the system. Business rules may determine how often customers are contacted to obtain feedback, how one feedback event affects another, including the system's decision to “declassify” a previously identified but not yet acted upon feedback event and therefore not proceed with any feedback requests related to it, how positive or negative detected customer feedback is handled by the system, and so forth. Business rules can be used to drive other behavior and invoke other systems. For example, a business might want to offer a concession to an unsatisfied customer or a reward to customers as an incentive for providing feedback. These and other types of system behavior can be defined by business rules.

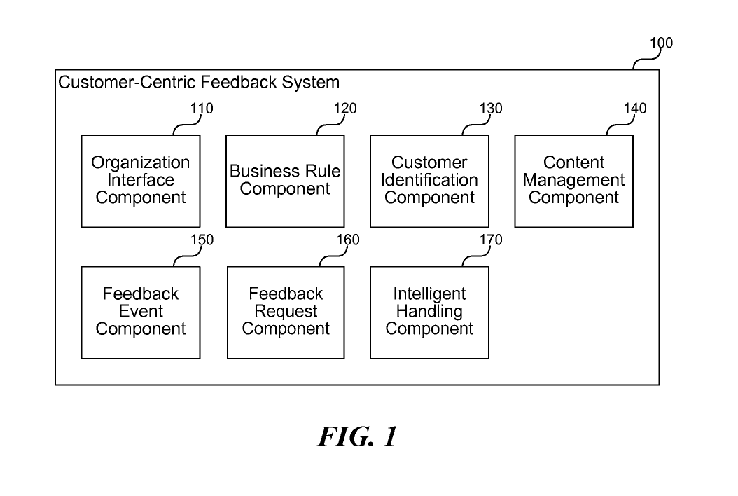

FIG. 1 is a block diagram that illustrates components of the customer-centric feedback system, in one embodiment. The system 100 includes an organization interface component 110, a business rule component 120, a customer identification component 130, a content management component 140, a feedback event component 150, a feedback request component 160, and an intelligent handling component 170. Each of these components is described in further detail herein.

The organization interface component 110 provides an interface to organizations that use the system to gather feedback and includes interface elements for defining business rules, identifying customers, and selecting feedback request content. The interface may include one more graphical user interfaces (GUIs), command-line user interfaces (CUIs), application-programming interfaces (APIs), web-based interfaces, and so forth. For example, the system may provide a graphical user interface for interaction with the users of an organization and an API for third party tools to leverage and/or extend the functionality of the system 100.

Organizations may include the entities that provide a product, service, or other reviewable interaction, as well as other types of organizations. For example, some organizations that use the system 100 may be third parties (a referring organization) that refer users to a particular merchant organization, while some merchants may delegate the task of obtaining feedback to third parties (reviewing organizations). The term “organization” herein is used generally to refer to any party that either directly or indirectly would use the system 100 to obtain feedback from customers. In some cases, a competitor may use the system 100 to obtain feedback from another organization's customers or an independent organization (like Consumer Reports) or customer referring organizations (like the Costco Auto Program) may use the system 100 to obtain feedback from users of someone else's products or services. The organization interface component 110 presents an interface to whoever is using the system to obtain feedback, and may provide different interfaces for each party when there are multiple parties to the process.

The business rule component 120 manages business rules setup by organizations, wherein the business rules determine how the system obtains feedback from customers and manages feedback state that determines the nature, timing, and methods of feedback requests. Business rules may be defined as an if/then set of priority ordered conditions or in any other form that allows an organization to define the feedback behavior the organization wants the system 100 to enforce. In some embodiments, the system 100 may provide a high level language for defining business rules, or may use off-the-shelf components for defining rules, such as structured query language (SQL), programming languages (e.g., JavaScript, C++, or others), and the like. The business rule component 120 receives business rules defined by organizations or default rules defined by the system operator, stores the business rules, and provides business rules to other components of the system 100 upon request for managing feedback state and sending feedback requests.

The customer identification component 130 receives an identification of customers from which an organization will use the system 100 to obtain feedback. Organizations may provide a list of customers upfront or inform the system 100 about specific customer contacts as they occur. Organizations can add new customers or remove old ones through the organization interface component 110. The customer identification component 130 receives a specification of a unique identifier that the organization uses to distinguish one customer from another. For example, the specification may indicate that customers are distinguished by name, email address, telephone number, Twitter handle, Facebook account, or some method unique to the organization, such as VIN or other identifier. The customer identification component 130 helps the system 100 detect separate feedback events that are related to the same customer and to manage a single set of state information for each customer across feedback events for that customer.

The content management component 140 manages messaging content related to obtaining customer feedback. In some embodiments, the messaging content may include forms with simple yes/no questions, multiple survey questions and possible answers (e.g., multiple choice), or other forms of obtaining customer feedback. The message content elements may be predefined by the system 100 and offered to organizations using the system 100 to select or the system 100 may allow organizations to define their own, such as through the organization interface component 110. In general, forms and other message content elements are designed so that the system 100 can interpret responses to the extent needed for managing feedback state. For example, if business rules provided by an organization indicate that no new feedback events should lead to customer feedback requests until problems indicated by past feedback requests are resolved, the feedback form is structured so that the system 100 can determine when a past feedback request indicates a problem. This determination may include one or more manual or automated steps, such as defining that a particular response to a survey question automatically indicates a problem, or providing surveys to human operators for manual review, where the human operators can then flag issues for follow up. Messaging content may span communications intended to foster customer compliance in completing the forms and customer satisfaction with the organization. Such content may serve to introduce, remind, apologize, thank, offer concessions to, reward, and market to the customer, and so forth.

The feedback event component 150 manages feedback events for one or more organizations, wherein a feedback event is a transaction or other contact with a customer for which an organization wants to obtain customer feedback. The system 100 may receive an indication from the organization when the organization has selected a feedback event. Alternatively or additionally, the system 100 may receive an indication when various types of customer contact occurs, and may apply business rules to determine whether a particular customer contact will be elevated to a feedback event. Once a feedback event has been identified, the feedback event component 150 is made aware of the event (whether by the organization or by other components of the system 100) and begins to manage feedback requests related to the feedback event.

The feedback request component 160 publishes requests for feedback to one or more customers of the one or more organizations that use the system 100, and embeds action references within the requests, such that upon activation the action references invoke the system to apply dynamic behavior at the time a customer is ready to provide feedback. The component 160 selects the contact method to use for reaching customers (e.g., email, phone, smartphone app, publishing a web page, and so forth), and may use different methods for reaching different customers (e.g., phone for customers over 65, email for customers under 65). The component 160 composes a feedback request (which may be an email, interactive voice response prompts, web page, or other request suited to the determined contact method) using one or more feedback forms and/or other feedback request message elements present in the content management component. The feedback request component 160 may also invoke the intelligent handling component 170 to use customer history or other information to tailor a particular feedback request to a particular customer. For example, a follow up request six months after a customer purchased a product may refer to the customer's responses during a three-month customer satisfaction survey to determine whether the customer's opinions about the product have changed.

The action reference embedded in the feedback request may be a link, button, hidden JavaScript, or other control or method that invokes the system to apply dynamic behavior to the interaction with the customer. As an example, suppose a customer has received three different emails from an organization or even multiple organizations, all of which are feedback requests that solicit feedback from the customer for separate customer contacts with the organization(s). These emails may be sitting in the customer's inbox, not yet accessed by the customer. Being aware of all three emails, the system 100 may want to apply some custom handling that simplifies the process of giving feedback for the customer. For example, the system 100 might compose one survey that allows the customer to answer 10 questions together instead of seven for the first feedback request, two for the second feedback request, and one for the third feedback request. Alternatively or additionally, the system 100 might allow the customer to open the first email and respond to the first feedback request normally, and then upon opening the second mail and invoking the action reference the system might simply thank the customer and provide a reward coupon for the recently received feedback, and not ask the customer to provide more that day.

In some embodiments, the action reference itself is of a variable nature, so that by the time the customer sees it its appearance, behavior, or other characteristics may change. For example, the action reference may originally be published as a button having the text “take a survey,” but may later appear as a button having the text, “click here for a reward for being our customer.” Where the action reference is embedded in a web page, this can be handled by JavaScript or other dynamic web technologies that are well known by those of ordinary skill in the art. In this way, the system 100 provides a type of communication with customers that is dynamic and current to the customer's latest experience with the organization. This increases the customer's overall satisfaction with the organization and makes communications with the customer more relevant and effective.

The intelligent handling component 170 manages a feedback state for each customer of one or more organizations and applies the state to all of potentially multiple feedback events associated with each customer. The feedback state summarizes the current state of the relationship with the customer as it relates to feedback, and may include information across feedback events, across organizations, and over a period of history with the customer. For example, although the system may be invoked from an email message or web page having an original purpose to solicit the customer's feedback about a recent service rendered, the feedback state may indicate that the customer has an unresolved refund request for a product ordered. The intelligent handling component 170 applies logic defined by the operator of the system 100 and/or provided by the organization(s) using the system 100 to determine how to respond to the current interaction with the customer. Although the customer may have clicked on an action reference originally linked to a survey about the service rendered, the intelligent handling component 170 may instead change the content associated with the link and take the customer through an interface for resolving the unresolved refund request. After the customer is satisfied with the refund request, the component 170 may then take the customer to the originally intended survey.

In this manner, the action references embedded in feedback requests by the system 100 allow the system 100 to tune the conversation with the customer at any point that the customer is about to give feedback to optimize the conversation for various goals (e.g., more accurate feedback, increased customer satisfaction, and so on). The feedback state changes over time after various interactions with a customer. For example, if a customer's response to a feedback request indicates customer dissatisfaction, the system may modify the state for that customer to pause subsequent feedback requests for new feedback events until a complaint resolution process defined by the organization's business rules can be followed. Once a customer's dissatisfaction with one contact event with the organization has been resolved, the system may again change the feedback state associated with the customer to allow queued or new feedback requests to be sent to the customer.

The computing device on which the customer-centric feedback system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, tablet computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

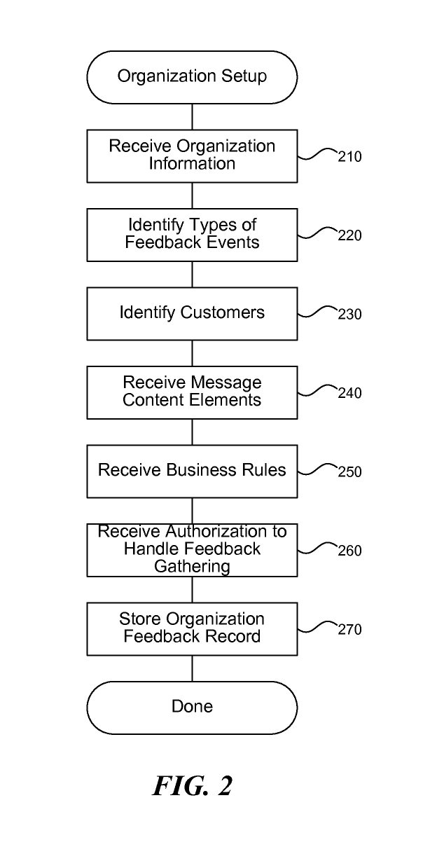

FIG. 2 is a flow diagram that illustrates processing of the customer-centric feedback system to set up the system to handle feedback for a particular organization, in one embodiment. Beginning in block 210, the system receives information that identifies an organization (or a representative or third party working on behalf of an organization) that will use the system to manage customer feedback. The system provides an organization user interface, such as a website or smartphone application, that organizations can use to interact with and sign up to use the system. Information received about the organization may include a variety of types of information, such as customers that the organization is interested in getting feedback from, types of events that will generate feedback requests, business rules for handling feedback across feedback events, survey forms that will be used to gather feedback, and so forth.

Continuing in block 220, the system identifies one or more types of feedback events in response to which the system will gather feedback from customers. The system may receive information from the organization that allows the system to know when customer contact occurs and under which conditions a contact with the customer will be classified as a feedback event for gathering feedback.

Continuing in block 230, the system identifies customers from which the organization wants to gather feedback. An organization may provide a customer list or may inform the system about customers as contact with each customer occurs. Organizations may acquire new customers over time and may inform the system each time a new customer is acquired.

Continuing in block 240, the system receives a selection of one or more message content elements that the organization will use for gathering feedback from one or more of the identified customers. The system may provide one or more predefined forms with message content elements, and/or may allow organizations to create their own. In some embodiments, the system provides a toolset of widgets and building blocks that organizations can use to create their own forms and message content. Among other things, these widgets and building blocks may include yes/no questions, multiple-choice questions, text response questions, or other common or proprietary ways of gathering feedback.

Continuing in block 250, the system receives one or more business rules from the organization wherein the business rules include a priority ordered set of conditions describing how to manage customer feedback state across multiple feedback events. The business rules provide a level of intelligence across all feedback sampling interactions with a customer that is absent from previous systems. The business rules allow for achieving better customer compliance in terms of responding to feedback requests, by reducing the likelihood that the customer will ignore or react negatively to the process due to feeling hounded or overwhelmed with requests, etc. The business rules allow for receiving more valid responses from customers, so that one instance where a customer experiences a negative contact with the organization does not skew or “color” feedback about other instances of contact with the same or possibly other organizations of a similar nature. Additionally, the business rules allow for sensitively and rewardingly communicating with the customer in a manner respectful of the customer's attention and time, so that the customer's overall perception of the organization is actually improved rather than negatively impacted by the feedback request process itself.

Continuing in block 260, the system receives authorization from the organization to handle gathering of feedback from customers for the organization. The organization may set up the system to tie into the organization's existing customer management systems, ecommerce site, or other systems, so that the customer-centric feedback management system is invoked upon the occurrence of customer contact deemed system-appropriate by the organization in order to apply all of the logic and handling described herein.

Continuing in block 270, the system stores an organization feedback record that includes the received customer information, feedback forms and other message content elements, and business rules associated with the organization's use of the system. The system may operate for many different organizations at the same time and may store multiple organization feedback records that describe how the system will handle feedback for each organization. After block 270, these steps conclude.

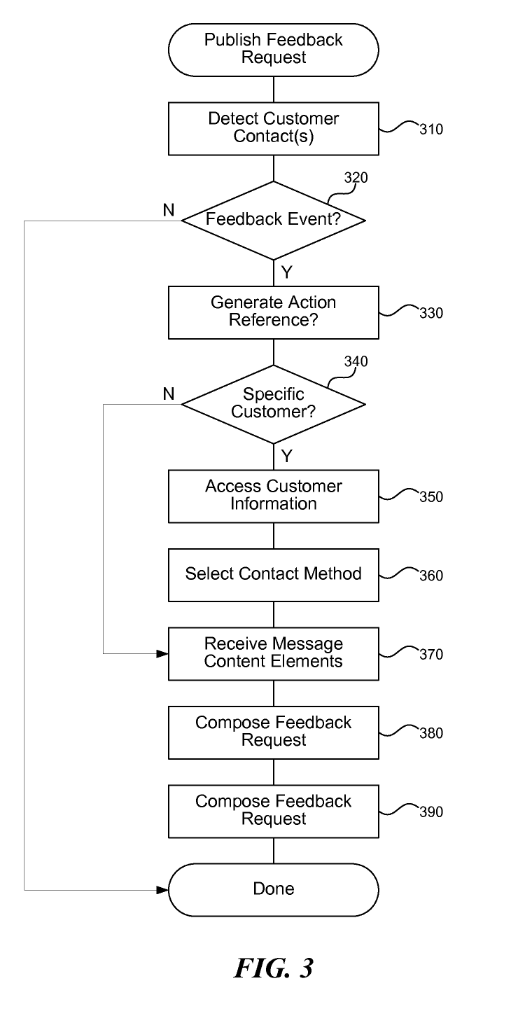

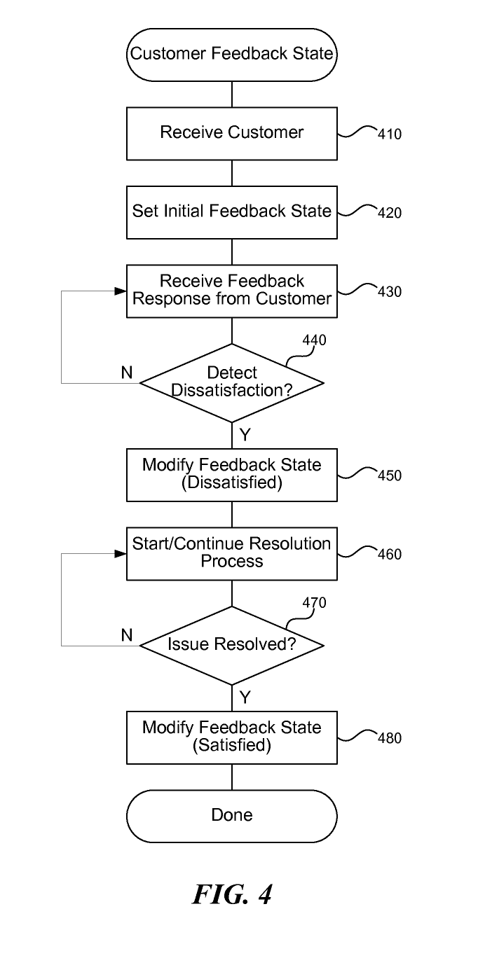

FIG. 3 is a flow diagram that illustrates processing of the customer-centric feedback system to publish a feedback request, in one embodiment. The system applies intelligence to each customer interaction related to providing feedback. To do this, any time the system is about to publish a communication to customers, the system embeds a customer viewable action reference such as a link, button or other user interface element that the customer will invoke upon accessing the published feedback request. A published feedback request could be an email message (e.g., an email to a specific customer in response to an event), a web page (e.g., any page of the organization with a “give feedback” button), or any other manner in which information is published to be viewable by one or more customers. When a customer invokes the action reference, the system performs the process described further with reference to FIG. 4. In the case of a publication viewable by more than one customer (e.g., a web page), the action reference might perform a different action for different customers as described in further detail herein.

Beginning in block 310, the system detects one or more customer contacts that have or may occur with an organization. The customer contact may be in the form of a purchase in a physical store or online, service rendered by the organization to the customer, an event the customer attended, a future contact that will occur after the organization publishes a web page that customers can access, and so forth. The system may detect the customer contact itself, such as via a website using the system to track interactions with customers, or may be informed by an external source, such as the organization or a vendor working for the organization, that the customer contact has occurred. The system may receive details that identify the customer, the type of contact, and other information such as pricing information, product or service information, information about the organization, and so on.

Continuing in decision block 320, if the system determines that the detected customer contact is a feedback event, then the system continues at block 330, else the system completes and takes no further action on this particular customer contact. The system may apply business rules received from an organization or other logic to determine which customer contacts will be classified as feedback events. For example, an organization may define that only every fifth purchase is a feedback event, or only one interaction with the customer per quarter is a feedback event. The system then enforces these conditions to gather feedback at the appropriate times or under the appropriate conditions.

Continuing in block 330, the system generates an action reference that can be invoked at the time of customer contact to establish a feedback state of a customer associated with the detected customer contact, so that the system can apply dynamic, intelligent handling appropriate for the customer's current feedback state. The action reference may invoke business rules set up by the organization publishing the feedback request to determine how to currently interact with the customer. Among other things, the business rules may specify conditions under which new feedback events are not allowed to generate feedback requests sent to the customer. The business rules may also specify that new feedback events can continue to generate feedback requests, but that they are modified or limited in some fashion that is desirable to the organization, or the business rules might specify that any past issues are first to be resolved with the customer, and then the customer will be allowed to proceed to a survey or other feedback request originally associated with the action reference. The system is flexible enough to allow organizations to define a virtually limitless set of logic and conditions that affect the handling of feedback events by the system.

Continuing in decision block 340, if the feedback request will be directed to a specific customer, then the system continues at block 350, else the system jumps to block 370.

Continuing in block 350, the system accesses customer information of the specific customer that will receive the feedback request. The customer information may include contact information for the customer (e.g., a phone number for calling or texting the customer, an email address of the customer, and so forth), past history of interactions with the customer that may affect the contents of a feedback request message, preferences specified by the customer or inferred by the system about the customer, an education level/native language/other characteristic of the customer that may affect the content of communications to the customer, or other customer information used for contacting the customer to receive feedback.

Continuing in block 360, the system selects a contact method for reaching the customer. Contact methods may include phone call, email, text message, Facebook message, instant messaging application messages, push notifications, or any other method of contacting the customer and obtaining feedback. The organization may specify a contact method, the customer may specify a contact method, or the system may have a default contact method if none has been specified. The system may use different contact methods for different customers, different organizations, or according to the business rules specified by the organization. In some embodiments, the system may select a communication agent and instruct the agent as to what communication method, action reference control, and feedback request to use. The communication agent may be some department of the organization, another organization, or even a competitor to the customer-centric feedback system. The system supports the use of communication agents to handle the actual communications, while still embedding a hook for invoking the system when a customer interacts with feedback requests communicated by communication agents.

Continuing in block 370, the system receives content that includes one or more message content elements associated with the feedback request, such as the body of an email message, the content of a web page, or other content that may accompany or be associated with the action reference. In some embodiments, a representative of the organization selects or creates particular feedback forms and message content elements when configuring the system to manage feedback requests for the organization. The feedback form may determine questions asked to the customer, information gathered from the customer, and so forth.

Continuing in block 380, the system composes a feedback request that includes the generated action reference and the received content. In the case of a communication to a single customer, the feedback request may also be based on the accessed customer information and selected contact method. For example, if the feedback request is a web page that multiple customers will be able to access, then the system builds the content of the page and includes the action reference as a link, button, or other control that will invoke the intelligence of the system upon activation by a customer. Alternatively, if the feedback request is a direct message to a specific customer and the contact method is via email, then the system may compose an email with a default greeting using the customer's name, the action reference, and any other content specified by the organization. Feedback requests may include fillable fields that are modified based on a particular customer's information, such as a greeting that includes the customer's name, an introductory section referencing the feedback event, questions that include specific details about the customer contact for which the feedback request has been generated, and so on.

Continuing in block 390, the system publishes the composed feedback request in a manner that makes the feedback request accessible to one or more customers in order to obtain feedback from them. The system may also store tracking information in a database or other data store associated with the system so that the system can manage the feedback request. For example, the system may send a reminder if the customer does not respond to the feedback request within a specified period, or may resend the feedback request if it is an email or similar message. For a web page, the system may capture data indicating which or how many customers have provided feedback via the web page, or compute other statistical information useful to organizations using the system. Under certain conditions, the system may respond to a customer's response to the feedback request, such as by asking follow-up questions, thanking/rewarding the customer for participation, and so on. After block 390, these steps conclude.

In some embodiments, the system may be operated directly by the organization from whose customers the feedback is being solicited. In other embodiments, the system may be operated by a service provider functioning as a third party vendor to the organization. In either case, other third party vendors of the organization that are in contact with its customers as part of their vendor role may play a role in the system's operation by serving as entities authorized by the organization to communicate with its customers on behalf of the system, known herein as communication agents. For example, a marketing firm may be serving as a vendor for the organization and in providing its services may publish communications to the organization's customers. As part of the marketing firm's vendor relationship with the organization the firm may be required to access an interface of the system in order to include appropriate system-generated feedback requests and/or action reference controls that the customer may see and interact with upon viewing the published communications from the marketing firm.

It is not uncommon today for an organization to contract with multiple feedback gathering entities at the same time for different departments or goals of the organization. Therefore, in some cases the third party vendor serving as a communication agent of the system may even play a distinct customer feedback role for certain of the organization's customers or types of customer contacts not handled by this instance of the system, but in its role as a system communication agent for the organization this same third party may include system-generated feedback requests and/or action reference controls. If the system is being operated by a feedback management vendor of the organization, then in some cases the other vendor serving as a communication agent may be a business competitor of the vendor operating the system. Additionally, a business may function as a service provider that does not contract directly with the organization but provides this system as a platform that one or more feedback management vendors of one or more possibly overlapping organizations may use. The system is flexible enough to allow managing some or all of such feedback efforts and to interact amicably with these other feedback-gathering entities so that the system can provide as much value as possible to the customer interactions managed by the system.

FIG. 4 is a flow diagram that illustrates processing of the customer-centric feedback system to manage feedback state associated with a customer, in one embodiment. The system performs the process described below for each customer managed by the system, so that any given customer at any given time may be in a different feedback state from other customers, based on a series of events that have happened between that customer, the organization, and/or the system. The same customer might also be in different feedback states with multiple organizations that might be using the system for managing their feedback processes. In some embodiments, the system may allow organizations to determine whether the system is permitted to consider cross-organization state to manage customer feedback. For example, if an organization has privacy requirements that would not permit this type of access, then that organization might require that the system be configured to not share the feedback state of its customers with other organizations using this same instance of the system. Further, configuration of feedback sharing may be fine-grained, filtering based on organization, customers, feedback event types, and so forth. For example, it might separately support or prohibit “sharing in” (benefiting from system knowledge of its customers' feedback states with other organizations) and “sharing out” (enabling other organizations to benefit from system knowledge of its customers' feedback states)

Beginning in block 410, the system receives information identifying a customer of an organization that will use the system to manage customer feedback. The information identifying the customer may include any of the types of identifiers described previously (e.g., email address, name, address, phone number, VIN, and so forth), as well as other information, such as contact information for the customer, any business rules specific to the customer or a group of customers, and so on.

Continuing in block 420, the system sets an initial customer feedback state. The system tracks state information for each customer that indicates whether the customer can currently receive new feedback requests, the customer's history of provided feedback, conditions under which the customer can be interacted with by the system, and other state information organizations want the system to track. The initial state may indicate that the customer can be contacted without restrictions, or may specify that certain introductory contact must occur first, such as a separate email from a distinct division of the organization explaining that the customer will soon be receiving feedback requests from the system. Organizations can configure the system to handle new customer state in any way that works for their organization.

Continuing in block 430, the system receives a feedback response from the customer, in response to an earlier feedback request (not shown). The feedback response may include one or more answers to questions from which the system can determine the sentiment or satisfaction level of the customer. For example, the response may include at least one answer to a survey question that indicates that the customer is dissatisfied. This causes the system to modify a feedback state for the customer to indicate that a resolution of the customer's dissatisfaction should occur.

Continuing in decision block 440, if the system detects customer dissatisfaction, then the system continues in block 450, else the system loops to block 430 to wait for the next feedback response. Conditions that indicate customer dissatisfaction can be defined by the organization, but may include things like an indication that a customer is dissatisfied in response to a previous feedback request, or an indication that a customer has received a maximum number of requests during a defined time (e.g., four requests per week) such that further requests would be excessive and potentially make the customer dissatisfied.

Continuing in block 450, the system modifies the customer feedback state managed by the system to indicate that the customer is dissatisfied and a resolution is needed. This may cause the system to invoke a resolution process to attempt to satisfy the customer at the next point that the customer invokes an action reference generated by the system, rather than whatever original intent the action reference had. As an example, a customer dissatisfied with service for the customer's automobile at a car dealership may not be asked for additional feedback about the dealership until the customer's dissatisfaction has been resolved. The customer may receive an email intended to ask for feedback about the dealership and click on a link in that email to give feedback, but because of the customer's feedback state indicating that the customer was previously dissatisfied, the system will first attempt the resolution process and may direct the customer to information for that resolution rather than the original feedback survey.

Resolution may include attempting to perform the service again, asking the customer about the service, giving the customer a concession (e.g., a $20 discount coupon), or other methods of resolving the conflict. The system may invoke one or more manual or automated processes to handle resolution. For example, the system might notify the organization about the problem so that the organization can have its customer relations department resolve the issue. Alternatively or additionally, the system might allow the organization to configure one or more automated types of resolution (e.g., first try apologizing to the customer, next try sending the customer a $20 coupon, and then only if the customer is still not happy escalate the issue to a representative to contact the customer and try to resolve the issue).

Continuing in block 460, the system initiates (or continues in subsequent iterations) an issue resolution process to attempt to resolve the condition that caused the customer to become dissatisfied. As discussed above, the resolution may include contacting the customer to try to resolve the issue, giving the customer a reward/concession, refunding the customer any payment associated with the negative purchase or service, and so on. The system may also survey the customer to determine whether the resolution process successfully resolved the customer's dissatisfaction.

Continuing in decision block 470, if the system determines that the issue has been resolved, then the system continues at block 480, else the system loops to block 460 to continue attempts at issue resolution. In some embodiments, the system may determine that the issue has been resolved by the exhaustion of a limited number of attempts to resolve the issue. For example, if the system has tried contacting the customer, refunding the customer, or giving the customer a concession because of a negative experience and the customer is still not satisfied, the system may determine that new feedback requests can continue because no resolution is available.

Continuing in block 480, the system modifies the customer feedback state managed by the system to indicate that the customer is no longer dissatisfied. This will allow subsequent action reference invocations to perform their previously planned action and may allow any paused or deferred feedback requests to be sent to the customer. Resuming feedback may modify a stored state associated with the customer, so that parts of the system that check state before performing other actions can become aware of the change in the customer's status. After block 480, these steps conclude.

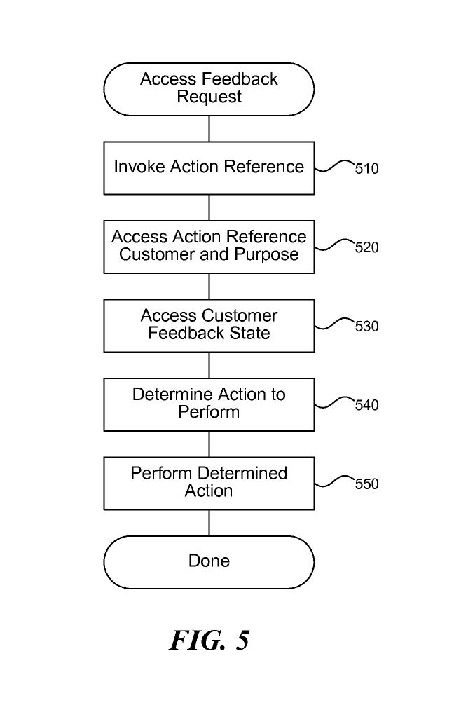

FIG. 5 is a flow diagram that illustrates processing of the customer-centric feedback system at the time a customer accesses a previously published feedback request, in one embodiment. Beginning in block 510, the system receives an indication that the customer has invoked an action reference embedded within the feedback request. The feedback request may be an email message, web page, or other publication and that action reference may be a hyperlink, button, or other control that can be clicked or otherwise invoked. The action reference may include information such as an identifier that can be used by the system to recall details about the feedback request, such as which customer the request was directed to, an original purpose of the request, where the feedback request is found (e.g., a web page uniform resource locator (URL) or other location), and so forth.

Continuing in block 520, the system accesses information associated with the action reference to identify a customer associated with the feedback request and an original reason for publishing the feedback request. The action reference may have this information embedded directly, such as via a customer name, number, or other identifier, or may have a generic number, such as a sequence number, that the system can look up in a database maintained by the system to get further information associated with the action reference. The action reference may also embed an original reason for sending the feedback request, such as a reference to a specific feedback form, message content element, feedback event, or other data.

Continuing in block 530, the system accesses a feedback state associated with the identified customer. The feedback state provides a source of aggregate information about the customer that encompasses feedback events, contact events, and potentially organizations. The aggregate information may indicate a variety of things about the customer, such as the customer's current state of satisfaction with a particular organization or with feedback requests in general. The aggregate information may also indicate a quantity or frequency of feedback requests received and/or preferred by the customer. The aggregate information is used by the system to determine what to do when an action reference is invoked.

Continuing in block 540, the system determines an action to perform based upon the accessed feedback state. The action performed may be an action associated with the original reason for publishing the feedback request or may be some substitute action determined by the system. Substitute actions may include a resolution process for previous dissatisfaction as described herein, some special reward for the customer based on past feedback responses, or any other action determined by the system or through business logic provided by one or more organizations.

Continuing in block 550, the system performs the determined action. Although described as a single action herein for ease of illustration, the system may determine multiple actions to perform and perform those multiple actions based on the customer's feedback state. For example, the system may first carry out a resolution process to solve a customer's dissatisfaction, and then carry out the original reason for sending the feedback request associated with the action reference, such as displaying survey questions to the customer. The actions that the system performs in response to an action reference being invoked are variable, and allow the system to insert a layer of intelligence at the point in time of interaction with the customer. The particular intelligent actions performed are determined by an implementer of the system and/or by business logic received from one or more organizations. After block 550, these steps conclude.

In some embodiments, the customer-centric feedback system includes a notion of referrer rights. For example, consider a membership retailer like Costco which has an auto dealer referral program (the Costco Auto Program) that, as a service to its members, negotiates special pricing for them with certain participating auto dealers its members, and then refers those members interested in purchasing a particular vehicle to the participating local dealer for that brand in order to complete the purchase at the program's pre-negotiated price. The system can, for example, allow the referrer to ask its members who have participated in the program for purchase experience reviews by sending feedback requests, and prevent the dealer (which may be using the same instance of the system) from issuing a feedback request for that particular event. The system may also allow the referrer to brand the system interface accessed by the member participants, such as a webpage, so that they associate the feedback requests with the referrer. This may be desirable to enforce the referrer's preference that the car dealers they work with not send out feedback requests that may diminish the referrer's value in the arrangement or make it more difficult for the referrer to obtain feedback about their members' experiences with dealers participating in the program. These and other variations are possible with the system described herein.

In some embodiments, the customer-centric feedback system stores information about each customer that indicates characteristics of the customer inferred by the system. For example, over the course of several rounds of feedback requests and responses, the system may discern whether a particular customer tends to be tough or easy on the organizations that the customer reviews. This can provide the system with cross-organization knowledge about a particular customer, and can allow the system to analyze and report on feedback given by appropriately weighting customers' responses to normalize their responses with those of other customers, thereby providing value to organizations and their industries with more valid, relevant and fine-grained information.

In some embodiments, the customer-centric feedback system filters feedback requests to further manage the customer relationship. For example, a customer may have dozens of service visits to a car dealership but may not want to receive dozens of feedback requests asking how each service visit went. In such cases, the system may determine that sampling every sixth visit of the customer would provide sufficient feedback for the organization's goals, and thus the system would filter out the other feedback requests (the first through fifth visits). As another example, a particular organization may be particularly interested in transmission service reviews. With knowledge of each customer contact, the system can determine those visits that are related to transmission service, and single out those visits for feedback requests, while not sending feedback requests for other visit types.

In some embodiments, the customer-centric feedback system performs dynamic form creation. While branching within a single survey is known in the art, doing this across surveys is not. The system can dynamically create survey forms based on one or more feedback requests to guide the customer to provide the types of feedback that the organizations that use the system are seeking. For example, based on a customer's answer to one question during one feedback request, the system might show or hide questions on a survey form related to another feedback request.

In some embodiments, the customer-centric feedback system performs personalized assembly of feedback request messages so that content of these messages is personalized based on information known and inferred about the customers that will receive the messages. For example, the system may take into account the customer's native language, education level, geographic location, or other factors to select content for the feedback request message that will be well understood by the customer that receives the message. This leads to better feedback compliance, reliability, validity and increased customer satisfaction with the overall feedback process.

From the foregoing, it will be appreciated that specific embodiments of the customer-centric feedback system have been described herein for purposes of illustration, but that various modifications may be made without deviating from the spirit and scope of the invention. Accordingly, the invention is not limited except as by the appended claims.

I/We claim:

1. A computer-implemented method to publish a feedback request that includes dynamic, intelligent handling upon subsequently accessing the request, the method comprising:
detecting one or more opportunities for customers to provide feedback to an organization;
determining whether a detected opportunity with a customer is a feedback event for which a feedback request will be communicated to the customer;
generating an action reference that can be invoked at the time a customer responds to the feedback request to establish a feedback state of the customer associated with the detected customer response;
if the feedback request will be directed to a specific customer, accessing customer information of the specific customer that will receive the feedback request;
receiving content that includes one or more message content elements associated with the feedback request;
composing a feedback request that includes the generated action reference and the received content; and
publishing the composed feedback request in a manner that makes the feedback request accessible to one or more customers in order to obtain feedback from them,
wherein the preceding steps are performed by at least one processor.

2. The method of claim 1 wherein detecting one or more opportunities for customer contact comprises determining that a customer has purchased a good or service from the organization.

3. The method of claim 1 wherein detecting one or more opportunities for customer feedback comprises determining that the organization is publishing a web page accessible to one or more customers.

4. The method of claim 1 wherein determining whether a detected opportunity for feedback is a feedback event comprises accessing business rules and applying the business rules to determine whether one or more criteria set up on behalf of the organization for identifying feedback events have been met.

5. The method of claim 1 wherein generating the action reference comprises generating an invokable reference that upon activation dynamically changes behavior based upon a current feedback state for the customer at a time of invoking the reference.

6. The method of claim 1 wherein generating the action reference comprises generating an invokable reference that upon activation accesses one or more business rules set up on behalf of the organization to determine dynamic behavior to be applied upon activating the action reference.

7. The method of claim 1 wherein generating the action reference comprises generating an invokable reference that upon activation: 1) determines whether a customer expressed dissatisfaction in response to a previous feedback request, and if so 2) triggers a resolution process to attempt to resolve the customer's expressed dissatisfaction, and 3) upon confirming resolution of the customer's dissatisfaction gathers feedback from the customer related to the current feedback request.

8. The method of claim 1 wherein accessing customer information comprises determining a contact method for reaching the customer with the published feedback request.

9. The method of claim 8 wherein determining a contact method comprises selecting a third party communication agent that may communicate with the customer.

10. The method of claim 1 wherein publishing the composed feedback request comprises publishing the action reference in a manner that allows a control for activating the reference to be modified at the time the action reference is presented to the customer.

11. The method of claim 1 wherein composing the feedback request comprises building content of a web page that will be accessible to multiple customers, wherein the web page includes the action reference as a control that a customer can activate to invoke dynamic handling of the published feedback request.

12. The method of claim 1 wherein composing the feedback request comprises building an email message for sending to one or more specific customers, wherein the body of the email message includes the action reference as a control that a recipient of the email message can activate to invoke dynamic handling of the published feedback request.

13. The method of claim 1 wherein publishing the feedback request comprises storing tracking information in a database that allows determining dynamic behavior when the action reference is activated by the customer accessing the published feedback request.

14. A computer system for intelligent customer-centric feedback management, the system comprising:
a processor and memory configured to execute software instructions embodied within the following components;
an organization interface component that provides an interface to organizations that use the system to gather feedback and includes interface elements for defining business rules, identifying customers, and selecting feedback request content.
a business rule component that manages business rules setup by organizations, wherein the business rules determine how the system obtains feedback from customers and manages feedback state that determines the nature, timing, and methods of feedback requests;
a customer identification component that receives an identification of customers from which an organization will use the system to obtain feedback;
a content management component that manages messaging content for obtaining customer feedback;
a feedback event component that manages feedback events for one or more organizations, wherein a feedback event is a transaction or other contact with a customer for which an organization wants to obtain customer feedback;
a feedback request component that publishes requests for feedback to one or more customers of the one or more organizations that use the system and embeds action references within the requests, such that upon activation the action references invoke the system to apply dynamic behavior at the time a customer is ready to provide feedback; and
an intelligent handling component that manages a feedback state for each customer of the one or more organizations and applies the state to multiple feedback events associated with each customer to dynamically gather feedback from each customer in a way that considers past feedback given by the customer.

15. The system of claim 14 wherein business rules are defined as a set of if/then priority ordered conditions.

16. The system of claim 14 wherein the messaging content managed by the content management component includes one or more predefined survey formats that an organization can populate to generate a survey to customers.

17. A computer-readable storage medium comprising instructions for controlling a computer system to dynamically handle a customer accessing a previously published feedback request, wherein the instructions, upon execution, cause a processor to perform actions comprising:
receiving an indication that the customer has invoked an action reference embedded within the feedback request;
accessing information associated with the action reference to identify a customer associated with the feedback request and an original reason for publishing the feedback request;
accessing a feedback state associated with the identified customer;
determining an action to perform based upon the accessed feedback state; and
performing the determined action.

18. The medium of claim 17 wherein accessing a feedback state associated with the identified customer comprises determining whether the customer previously expressed dissatisfaction in response to another feedback request.

19. The medium of claim 17 wherein determining an action to perform based upon the accessed feedback state comprises determining an action that is different than an action associated with the original reason for publishing the feedback request.

20. The medium of claim 17 wherein determining an action to perform comprises determining a series of actions to perform based on the accessed feedback state and the original reason for publishing the feedback request.
